(19) United States
(12) Patent Application Publication
(10) Pub. No.: US 2014/0268063 A1
(43) Pub. Date: Sep. 18, 2014

(54) LIGHTING DEVICE AND PROJECTOR

(71) Applicant: Seiko Epson Corporation, Tokyo (JP)

(72) Inventors: Koichi AKIYAMA, Matsumoto-shi (JP); Kiyoshi KUROI, Matsumoto-shi (JP)

(73) Assignee: Seiko Epson Corporation, Tokyo (JP)

(21) Appl. No.: 14/201,116

(22) Filed: Mar. 7, 2014

(30) Foreign Application Priority Data
Mar. 15, 2013 (JP) 2013-053727

(51) Int. Cl. G03B 21/20; F21V 13/08

(52) U.S. Cl. CPC G03B 21/204; F21V 13/08
USPC 353/20; 362/19

(57) ABSTRACT

A lighting device includes a light source that emits a first light flux of a first wavelength band, a fluorescence light emitting element including a phosphor layer which produces, when excited by light of the first wavelength band, light of a second wavelength band, a polarization separation element that has a polarization separation function for light of the first wavelength band and transmits or reflects light of the second wavelength band, a retardation film disposed in an optical path between the polarization separation element and the phosphor layer, a first reflector disposed in an optical path between the retardation film and the phosphor layer, and a second reflector that reflects the light produced by the phosphor layer. The first reflector reflects part of the first light flux toward the polarization separation element, and transmits the other part of the first light flux toward the phosphor layer.

### BACKGROUND

1. Technical Field

The present invention relates to a lighting device and a projector.

2. Related Art

There is a widely known projector of related art in which a light modulator is illuminated with illumination light outputted from a lighting device and modulated image light outputted from the light modulator is enlarged and projected through a projection optical system on a screen.

A discharge lamp, such as an ultrahigh-pressure mercury lamp, is used as a light source of the projector in related art. On the other hand, a discharge lamp of this type has problems of a relatively short life, a difficulty in instantaneous light emission, degradation of a liquid crystal panel due to ultraviolet light radiated from the lamp, and others.

In view of the fact described above, a laser light source, such as a semiconductor laser (LD) capable of emitting high-luminance, high-power light, has received attention as the light source of the projector in place of a discharge lamp. A laser light source has the following advantages over a discharge lamp and other light sources of related art: compactness; excellent color reproducibility; instantaneous light emission; and a long life.

Further, a lighting device using a laser light source allows use of excitation light (blue light) emitted from a semiconductor laser and fluorescence light (yellow light) produced when the excitation light excites a phosphor (see JP-A-2012-123179, for example).

In the light source apparatus described in JP-A-2012-123179, a light emitting area where a phosphor is provided and a non-light-emitting area where no phosphor is provided are alternately arranged in the circumferential direction of a rotating fluorescence wheel. In this configuration, since the fluorescence light (yellow light) emitted from the light emitting areas and the excitation light (blue light) reflected off the non-light-emitting areas are alternately outputted, white light is apparently outputted but, in fact, no white light is outputted.

### SUMMARY

An advantage of some aspects of the invention is to provide a lighting device that is compact and lightweight and capable of efficiently outputting illumination light and a projector including the lighting device.

A lighting device according to an aspect of the invention includes a light source that emits a first light flux of a first wavelength band, a fluorescence light emitting element including a phosphor layer and a base that supports the phosphor layer, the phosphor layer producing, when excited by light of the first wavelength band, light of a second wavelength band different from the first wavelength band, a polarization separation element that is provided in an optical path between the light source and the phosphor layer, has a polarization separation function for light of the first wavelength band, and transmits or reflects light of the second wavelength band, a retardation film disposed in an optical path between the polarization separation element and the phosphor layer, a first reflector that is disposed in an optical path between the retardation film and the phosphor layer, reflects part of the first light flux toward the polarization separation element, and transmits other part of the first light flux toward the phosphor layer, and a second reflector that is disposed on the opposite side of the phosphor layer to the first reflector and reflects the light produced by the phosphor layer.

According to the configuration of the lighting device described above, the first reflector disposed in the optical path between the retardation film and the phosphor layer reflects part of the first light flux toward the polarization separation element and transmits the other part of the first light flux toward the phosphor layer. Further, the second reflector, which is disposed on the opposite side of the phosphor layer to the first reflector, reflects the light produced by the phosphor layer. As a result, illumination light that is a combination of light of the first wavelength band and light of the second wavelength band can be provided. A lighting device that is compact and lightweight and capable of efficiently outputting illumination light can thus be provided.

It is preferable that a quarter wave plate is used as the retardation film.

According to the configuration, the polarization direction of the light reflected off the first reflector can be converted into a direction rotated by about 90° from the polarization direction of the first light flux incident from the polarization separation element on the retardation film.

It is preferable that the first reflector is a diffusive reflection surface.

According to the configuration, the diffusive reflection surface can diffusively reflect part of the first light flux.

The diffusive reflection surface may be formed by performing texture processing or dimple processing on a surface of the phosphor layer.

According to the configuration, a diffusive reflection surface suitable for diffusively reflecting part of the first light flux can be formed on the opposite surface of the phosphor layer to the surface facing the base.

It is preferable that the second reflector is a mirror-finished reflection surface.

According to the configuration, the light produced by the phosphor layer can be reflected off the mirror-finished reflection surface in a mirror reflection process.

The mirror-finished reflection surface may be a reflection film provided between the phosphor layer and the base.

According to the configuration, a mirror-finished reflection surface suitable for reflecting the light produced by the phosphor layer in mirror reflection process can be provided.

The base may be disposed on the opposite side of the phosphor layer to a surface thereof on which the other part of the first light flux is incident, and the mirror-finished reflection surface may be a light reflective surface of the base.

According to the configuration, a mirror-finished reflection surface suitable for reflecting the light produced by the phosphor layer with specular reflection can be provided.

It is preferable that the phosphor layer is attached to the base with a light reflective, inorganic adhesive provided on a side surface of the phosphor layer.

According to the configuration, the light reflective, adhesive can reflect light that leaks through the side surface of the phosphor layer back into the phosphor layer, whereby the light produced by the phosphor layer can be extracted with increased efficiency.

It is preferable that a semiconductor laser is used as the light source, and that the polarization direction of the first light flux incident on the polarization separation element coincides with one of the polarization direction of polarized light that the polarization separation element transmits and the polarization direction of polarized light that the polarization separation element reflects.

According to the configuration, not only can high-luminance, high-power illumination light be provided, but also the size of the light source can be reduced. Further, since the polarization direction of the first light flux coincides with one of the polarization direction of polarized light that the polarization separation element transmits and the polarization direction of polarized light that the polarization separation element reflects, the polarization separation element efficiently reflects or transmits the first light flux emitted from the semiconductor laser toward the fluorescence emitting element.

An array light source having the semiconductor laser disposed therein in a plurality of positions may be used as the light source.

According to the configuration, the array light source in which a plurality of semiconductor laser are arranged can be used to provide illumination light having higher luminance and higher power.

It is preferable that a collimator optical system is disposed between the light source and the polarization separation element.

According to the configuration, the first light flux emitted from the light source can be converted into parallelized light that is then allowed to be incident on the polarization separation element.

A projector according to another aspect of the invention includes a lighting device that radiates illumination light, a light modulator that modulates the illumination light in accordance with image information to form image light, and a projection optical system that projects the image light, and the lighting device is any of the lighting devices described above.

According to the configuration of the projector described above, the projector can display an image of high quality and can be further reduced in size.

### BRIEF DESCRIPTION OF THE DRAWINGS

The invention will be described with reference to the accompanying drawings, wherein like numbers reference like elements.

FIG. 1 is a plan view showing a schematic configuration of a projector.

FIG. 2 is a plan view showing a schematic configuration of a lighting device according to a first embodiment.

FIGS. 3A to 3C are plan views showing examples of the configuration of a light emitting layer provided in a fluorescence light emitting element.

FIG. 4 is a plan view showing a schematic configuration of a lighting device according to a second embodiment.

### DESCRIPTION OF EXEMPLARY EMBODIMENTS

Embodiments of the invention will be described below in detail with reference to the drawings.

In the drawings used in the following description, a characteristic portion is enlarged for convenience in some cases for clarity of the characteristic thereof, and hence the dimension ratio of each component is not always equal to an actual dimension ratio.

### Projector

An example of a projector 1 shown in FIG. 1 will first be described.

FIG. 1 is a plan view showing a schematic configuration of the projector 1.

The projector 1 is a projection-type image display apparatus that displays color video images on a screen (projection surface) SCR. The projector 1 uses three light modulators corresponding to the following color light fluxes: red light LR; green light LG; and blue light LB. The projector 1 further uses a semiconductor laser (laser light source) capable of emitting high-luminance, high-power light as a light source of a lighting device.

Specifically, the projector 1 generally includes a lighting device 2, which radiates illumination light WL, a color separation optical system 3, which separates the illumination light WL from the lighting device 2 into the red light LR, the green light LG, and the blue light LB, a light modulator 4R, a light modulator 4G, and a light modulator 4B, which modulate the color light fluxes LR, LG, and LB in accordance with image information to form image light fluxes corresponding to the color light fluxes LR, LG, and LB, a light combining optical system 5, which combines the image light fluxes from the light modulators 4R, 4G, and 4B with one another, and a projection optical system 6, which projects the image light from the light combining optical system 5 toward the screen SCR, as shown in FIG. 1.

The lighting device 2, which is a lighting device to which the invention is applied and which will be described later, provides the illumination light (white light) WL by mixing excitation light (blue light) emitted from the semiconductor laser with fluorescence light (yellow light) produced when the excitation light excites a phosphor. The illumination light WL radiated from the lighting device 2 is adjusted to have a uniform illuminance distribution and directed toward the color separation optical system 3.

The color separation optical system 3 generally includes a first dichroic mirror 7a and a second dichroic mirror 7b, a first total reflection mirror 8a, a second total reflection mirror 8b, and a third total reflection mirror 8c, and a first relay lens 9a and a second relay lens 9b.

Among the components in the color separation optical system 3, the first dichroic mirror 7a has a function of separating the illumination light WL from the lighting device 2 into the red light LR and the other color light fluxes LG and LB and transmits the separated red light LR whereas reflecting the other color light fluxes LG and LB. On the other hand, the second dichroic mirror 7b has a function of separating the other color light fluxes LG and LB into the green light LG and the blue light LB and reflects the separated green light LG whereas transmitting the blue light LB.

The first total reflection mirror 8a is disposed in the optical path of the red light LR and reflects the red light LR, which has passed through the first dichroic mirror 7a, toward the light modulator 4R. On the other hand, the second total reflection mirror 8b and the third total reflection mirror 8c are disposed in the optical path of the blue light LB and reflect the blue light LB, which has passed through the second dichroic mirror 7b, toward the light modulator 4B. No total reflection mirror needs to be disposed in the optical path of the green light LG, which is reflected off the second dichroic mirror 7b toward the light modulator 4G.

The first relay lens 9a and the second relay lens 9b are disposed in the optical path of the blue light LB in positions downstream of the second dichroic mirror 7b. The first relay lens 9a and the second relay lens 9b have a function of compensating optical loss of the blue light LB due to a longer optical length of the blue light LB than those of the red light LR and the green light LG.

The light modulators 4R, 4G, and 4B are each formed of a liquid crystal panel and modulate the color light fluxes LR, LG, and LB while transmitting them in accordance with image information to form image light fluxes. A pair of polarizers (not shown) are provided on the light incident side and the light exiting side of each of the light modulators 4R, 4G, and 4B and transmit only light linearly polarized in a specific direction.

Further, on the light incident side of the light modulators 4R, 4G, and 4B are disposed a field lens 10R, a field lens 10G, and a field lens 10B, which parallelize the color light fluxes LR, LG, and LB to be incident on the light modulators 4R, 4G, and 4B.

The light combining optical system 5, which is formed of a cross dichroic prism, receives the image light fluxes from the light modulators 4R, 4G, and 48, combines the image light fluxes corresponding to the color light fluxes LR, LG, and LB with one another, and outputs the combined image light toward the projection optical system 6.

The projection optical system 6 is formed of a group of projection lenses and enlarges and projects the combined image light from the light combining optical system 5 toward the screen SCR. Enlarged color video images are thus displayed on the screen SCR.

### Lighting Device

A description will next be made of specific embodiments of a lighting device to which the invention is applied and which is used as the lighting device 2.

### First Embodiment

A description will first be made of a lighting device 20A shown in FIG. 2 as a first embodiment.

FIG. 2 is a plan view showing a schematic configuration of the lighting device 20A.

The lighting device 20A generally includes an array light source 21, a collimator optical system 22, an afocal optical system 23, a homogenizer optical system 24, an optical element 25A including a polarization separation element 50A, a retardation film 26, an optical pickup system 27, a fluorescence light emitting element 28, an optical integration optical system 29, a polarization conversion element 30, a superimposing optical system 31, as shown in FIG. 2.

The array light source 21 is formed of an array of a plurality of semiconductor lasers 21a. Specifically, the plurality of semiconductor lasers 21a are arranged in an array in a plane perpendicular to an optical axis. The optical axis of a first light source portion 21A is called an optical axis ax1. The optical axis of a second light source portion 21B, which will be described later, is called an optical axis ax2. The optical axis ax1 and the optical axis ax2 are present in the same flat plane and perpendicular to each other. Along the optical axis ax1 are disposed the array light source 21, the collimator optical system 22, the afocal optical system 23, the homogenizer optical system 24, and the optical element 25A in this order. On the other hand, along the optical axis ax2 are disposed the fluorescence light emitting element 28, the optical pickup system 27, the retardation film 26, the optical element 25A, the optical integration optical system 29, the polarization conversion element 30, and the superimposing optical system 31 in this order.

Each of the semiconductor lasers 21a emits excitation light (blue light) BL having a peak wavelength, for example, within a wavelength range from 440 to 480 nm as a first light flux of a first wavelength band. The excitation light BL emitted from each of the semiconductor lasers 21a is coherent linearly polarized light and directed in parallel to the optical axis ax1 toward the polarization separation element 50A.

The array light source 21 is so configured that the polarization direction of the excitation light BL emitted from each of the semiconductor lasers 21a coincides with the polarization direction of a polarized light component (S-polarized light component, for example) reflected off the polarization separation element 50A. The excitation light BL outputted from the array light source 21 is then incident on the collimator optical system 22.

The collimator optical system 22 converts the excitation light BL outputted from the array light source 21 into parallelized light and is formed of a plurality of collimator lenses 22a arranged, for example, in an array in correspondence with the semiconductor lasers 21a. The excitation light BL having passed through the collimator optical system 22, where the excitation light EL is converted into parallelized light, is then incident on the afocal optical system 23.

The afocal optical system 23 adjusts the size (spot diameter) of the excitation light BL and is formed, for example, of two afocal lenses 23a and 23b. The excitation light BL having passed through the afocal optical system 23, where the size of the excitation light BL is adjusted, is then incident on the homogenizer optical system 24.

The homogenizer optical system 24 converts the optical intensity distribution of the excitation light BL into a uniform state (what is called top-hat distribution) and is formed, for example, of a pair of multilens arrays 24a and 24b. The excitation light BL having passed through the homogenizer optical system 24, where the optical intensity distribution of the excitation light BL is converted into a uniform state, is then incident on the fluorescence light emitting element 28 via the polarization separation element 50A.

The optical element 25A is formed, for example, of a wavelength selective dichroic prism having an inclined surface K, which is inclined with respect to the optical axis ax1 by 45°. The inclined surface K is also inclined with respect to the optical axis ax2 by 45°. Further, the optical element 25A is so disposed that the intersection point of the optical axes ax1 and ax2 perpendicular to each other coincides with an optical center of the inclined surface K. The wavelength selective polarization separation element 50A is disposed on the inclined surface K.

The polarization separation element 50A has a polarization separation function of separating the excitation light BL of the first wavelength band incident on the polarization separation element 50A into an S-polarized light component (one polarized light component) and a P-polarized light component (other polarized light component) with respect to the polarization separation element 50A. The polarization separation element 50A reflects the S-polarized light component of the excitation light BL whereas transmitting the P-polarized light component of the excitation light BL. The polarization separation element 50A further has a color separation function of transmitting part of the light incident on the polarization separation element 50A, specifically, light of a second wavelength band different from the first wavelength band irrespective of the polarization state of the light of the second wavelength band. The optical element 25A is not limited to a prism-shaped dichroic prism but may be a parallel-plate-shaped dichroic mirror.

The excitation light BL incident on the polarization separation element 50A is then reflected toward the fluorescence light emitting element 28 as S-polarized excitation light BLs because the polarization direction of the incident excitation light BL coincides with the polarization direction of the S-polarized light component.

The retardation film 26 is formed of a quarter wave plate (λ/4 plate) disposed in the optical path between the polarization separation element 50A and a phosphor layer 32 of the fluorescence light emitting element 28. The S-polarized (linearly polarized) excitation light BLs incident on the retardation film 26 is converted into circularly polarized excitation light BLC and then incident on the optical pickup system 27.

The optical pickup system 27 collects the excitation light BLc along the optical path toward the phosphor layer 32 and is formed, for example, of pickup lenses 27a and 27b. Although not shown in FIG. 2, a first reflector 32a is provided in the optical path between the retardation film 26 and the phosphor layer 32. The configuration of the first reflector 32a will be described in detail with reference to FIGS. 3A to 3C, which will be described later.

The first reflector 32a reflects part of the excitation light BLc incident through the optical pickup system 27 or light BLc1 toward the polarization separation element 50A whereas transmitting the other part of the excitation light BLc incident through the optical pickup system 27 or light BLc2 toward the phosphor layer 32. The first reflector 32a further transmits light of the second wavelength band.

The fluorescence light emitting element 28 has the phosphor layer 32 and a substrate (base) 33, which supports the phosphor layer 32. In the fluorescence light emitting element 28, the phosphor layer 32 is fixed to and supported by the substrate 33 with the opposite surface of the phosphor layer 32 to the side thereof on which the light BLc2 is incident being in contact with the substrate 33.

The phosphor layer 32 has a phosphor that absorbs the excitation light BLc2, which is light of the first wavelength band, and is excited thereby, and the phosphor excited by the excitation light BLc2 produces fluorescence light (yellow light) having a peak wavelength within a wavelength range, for example, from 500 to 700 nm as light of the second wavelength band different from the first wavelength band.

The phosphor layer 32 is preferably made of a material that excels in heat resistance and surface processability. When the phosphor layer 32 is not rotated, which is the case of the present embodiment, the phosphor layer 32 needs to be highly heat resistant and readily cooled because no cooling effect provided by rotation of the phosphor layer 32 is expected. For example, the phosphor layer 32 is preferably a fluorescence layer formed of an inorganic binder made, for example, of alumina and having phosphor particles dispersed in the binder or a fluorescence layer using no binder but made of sintered phosphor particles.

On the other hand, little back scattering of the excitation light BLc is expected due to a small difference in refractive index in the thus configured phosphor layer 32. The first reflector 32a, which reflects part of the excitation light BLc, is therefore provided in the optical path between the phosphor layer 32 and the retardation film 26.

It is conceivable to use light having passed through the phosphor layer 32 and having been then reflected back off a second reflector as the illumination light WL. In this case, however, the phosphor layer 32 disturbs the polarization state of the linearly polarized light. Light having a polarization state disturbed by the phosphor layer 32 has a light component that cannot pass through the polarization separation element 50A, resulting in a decrease in efficiency in use of the illumination light WL.

In the present embodiment, the first reflector 32a is provided in the optical path between the retardation film 26 and the phosphor layer 32, as shown in FIGS. 3A, 3B, and 3C.

The first reflector 32a is formed of a diffusive reflection surface provided on a surface of the phosphor layer 32, specifically, the surface thereof on which the excitation light BLc2 is incident. The diffusive reflection surface has a function of diffusively reflecting the light BLc1, which is part of the excitation light BLc, toward the polarization separation element 50A.

Specifically, the diffusive reflection surface can be formed, for example, by performing texture processing on a surface of the phosphor layer 32, specifically, the surface thereof on which the excitation light BLc2 is incident, as shown in FIG. 3A. In this case, based on back scattering from the roughened surface, the first reflector 32a can diffusively reflect the light BLc1, which is part of the excitation light BLc, toward the polarization separation element 50A.

The diffusive reflection surface can instead be formed, for example, by performing dimple processing on the surface of the phosphor layer 32 on which the excitation light BLc2 is incident, as shown in FIG. 3B. In this case, based on Fresnel reflection from the surface having a large number of convex surfaces formed thereon, the first reflector 32a can diffusively reflect the light BLc1, which is part of the excitation light BLc, toward the polarization separation element 50A.

The diffusive reflection surface is not limited to the surface on which a large number of convex surfaces are formed in dimple processing but may, for example, be a surface on which a large number of concave surfaces are formed in dimple processing as shown in FIG. 3C or a surface on which a large number of convex and concave surfaces (not shown) are formed (combination of convex and concave surfaces) in dimple processing.

A reflection enhancement layer (not shown) may further be provided on a surface of the first reflector 32a, specifically, the surface thereof on which the excitation light BLc is incident. In this case, the proportion of the light BLc1 reflected off the first reflector 32a can be increased.

In the present embodiment, a second reflector 32b is provided on the opposite side of the phosphor layer 32 to the side where the excitation light BLc is incident, as shown in FIGS. 3A, 3B, and 3C. The second reflector 32b is formed of a mirror-finished reflection surface. The mirror-finished reflection surface has a function of reflecting part of the fluorescence light produced by the phosphor layer 32 or fluorescence light YL1.

Specifically, the mirror-finished reflection surface can be formed by providing a reflection film 32c on the opposite surface of the phosphor layer 32 to the side on which the excitation light BLc2 is incident.

The mirror-finished reflection surface can instead be formed, when the substrate 33 has light reflectivity, by forming no reflection film 32c but mirror-finishing a surface of the substrate 33, specifically the surface thereof facing the phosphor layer 32.

In the fluorescence light emitting element 28, the phosphor layer 32 is fixed to the substrate 33 with a light reflective, inorganic adhesive S provided on the side surface of the phosphor layer 32, as shown in FIG. 2. In this case, the light reflective, inorganic adhesive S can reflect light that leaks through the side surface of the phosphor layer 32 back into the phosphor layer 32. The fluorescence light produced by the phosphor layer 32 can thus be extracted with increased efficiency.

A heat sink 34 is provided on the opposite surface of the substrate 33 to the surface thereof that supports the phosphor layer 32. Heat generated in the fluorescence light emitting element 28 can be dissipated through the heat sink 34, whereby the phosphor layer 32 will not be thermally degraded.

Part of the fluorescence light produced by the phosphor layer 32 or the fluorescence light YL1 is reflected off the second reflector 32b and exits out of the phosphor layer 32. The other part of the fluorescence light produced by the phosphor layer 32 or fluorescence light YL2 exits out of the phosphor layer 32 without reaching the second reflector 32b. Fluorescence light YL (yellow light) thus exits out of the phosphor layer 32 toward the polarization separation element 50A.

The light (blue light) Blc1 reflected off the first reflector 32a passes through the optical pickup system 27 and the retardation film 26 again. The light BLc1, which is circularly polarized light, is converted when passing through the retardation film 26 into P-polarized (linearly polarized) light BLp. The light BLp then passes through the polarization separation element 50A.

The fluorescence light (yellow light) YL having exited out of the phosphor layer 32 toward the polarization separation element 50A passes through the optical pickup system 27 and the retardation film 26. In this process, the fluorescence light YL, which is a randomly polarized light flux, remains randomly polarized after passing through the retardation film 26 and enters the polarization separation element 50A. The fluorescence YL then passes through the polarization separation element 50A.

The blue light BLp and the yellow light YL having passed through the polarization separation element 50A are then mixed with each other to form the illumination light (white light) WL. The illumination light WL passes through the polarization separation element 50A and then enters the optical integration optical system 29. To provide white light (illumination light) WL having a high color temperature, the reflectance of first reflector 32a at which the first reflector 32a reflects the light BLc1 is preferably set to a value ranging from 10 to 25%, more preferably from 15 to 20%.

The optical integration optical system 29 makes the luminance distribution (illuminance distribution) of light incident thereon uniform and is formed of a pair of lens arrays 29a and 29b. Each of the pair of lens arrays 29a and 29b has a plurality of lenses arranged in an array. The illumination light WL having passed through the optical integration optical system 29, where the luminance distribution of the illumination light WL is made uniform, is then incident on the polarization conversion element 30.

The polarization conversion element 30 aligns the polarization directions of the light rays that form the illumination light WL with one another and is formed, for example, of a polarization separation film and a retardation film. The polarization conversion element 30, in particular, converts the one polarized light component into the other polarized light component (S-polarized light component into P-polarized light component, for example) so that the non-polarized fluorescence light YL can be converted into light which is polarized in the direction parallel to the polarization direction of the light BLp (P-polarized light). The illumination light WL having passed through the polarization conversion element 30, where the illumination light WL is converted into linearly polarized light, is then incident on the superimposing optical system 31.

The superimposing optical system 31 is formed of a superimposing lens 31a, and light rays that form the illumination light WL are superimposed on one another when passing through the superimposing optical system 31, whereby the luminance distribution of the illumination light WL is made uniform and the axial symmetry thereof around the light ray axis is increased.

The thus configured lighting device 20A can provide illumination light (white light) WL that is a combination of the light (blue light) BLc1 reflected off the first reflector 32a and the fluorescence light (yellow light) YL emitted from the phosphor layer 32 (fluorescence light emitting element 28).

In this case, the light BLc1 reflected off the first reflector 32a has a small amount of disturbance in the polarization state as compared with a case where the excitation light having passed through the phosphor layer 32 and having been then reflected back off the second reflector 32b is used as the illumination light WL, whereby a greater amount of illumination light WL passes through the polarization separation element 50A. As a result, illumination light WL having a high color temperature can be efficiently produced. Further, the lighting device 20A can be more compact and lightweight than a lighting device of related art.

Therefore, when the thus configured lighting device 20A is used as the lighting device 2 provided in the projector 1, the size and weight of each of the lighting device 2 and the projector 1 can be reduced with images displayed in excellent image quality.

### Second Embodiment

A lighting device 20B shown in FIG. 4 will next be described as a second embodiment.

In the following description, the same portions as those of the lighting device 20A shown in FIG. 2 will not be described but have the same reference characters in the drawings.

In the lighting device 208B, the array light source 21, the collimator optical system 22, the afocal optical system 23, the homogenizer optical system 24, an optical element 25B including a polarization separation element 50B, the retardation film 26, the optical pickup system 27, and the fluorescence light emitting element 28 are disposed in this order along the optical axis ax1, as shown in FIG. 4. Further, the optical element 25B, the optical integration optical system 29, the polarization conversion element 30, and the superimposing optical system 31 are disposed in this order along the optical axis ax2.

The polarization separation element 50B has a polarization separation function of separating the excitation light BL of the first wavelength band incident on the polarization separation element 50B into an S-polarized light component (one polarized light component) and a P-polarized light component (other polarized light component) with respect to the polarization separation element 50B. The polarization separation element 50B reflects the S-polarized light component of the excitation light BL whereas transmitting the P-polarized light component of the excitation light BL. The polarization separation element 50B further has a color separation function of transmitting part of the light incident on the polarization separation element 508, specifically, light of the second wavelength band different from the first wavelength band irrespective of the polarization state of the light of the second wavelength band.

The lighting device 20B is so configured that the polarization direction of the excitation light BL emitted from each of the semiconductor lasers 21a provided in the array light source 21 coincides with the polarization direction of the polarized light component that is allowed to pass through the polarization separation element 50B (P-polarized light component). Other than the point described above, the lighting device 20B is basically the same as the lighting device 20A.

In the thus configured lighting device 20B, the excitation light BL incident on the polarization separation element 50B passes therethrough as P-polarized excitation light BLp toward the fluorescence light emitting element 28.

On the other hand, the light (blue light) BLc1 reflected off the first reflector 32a passes through the retardation film 26 again. The light BLc1, which is circularly polarized light, is converted, when passing through the retardation film 26, into S-polarized (linearly polarized) light BLs. The S-polarized excitation light BLs is then reflected off the polarization separation element 50B toward the optical integration optical system 29. Similarly, the fluorescence light (yellow light) YL emitted from the phosphor layer 32 (fluorescence light emitting element 28) is reflected off the polarization separation element 50B toward the optical integration optical system 29.

The thus configured lighting device 20B can provide illumination light (white light) WL that is a combination of the light (blue light) BLc1 reflected off the first reflector 32a and the fluorescence light (yellow light) YL emitted from the phosphor layer 32 (fluorescence light emitting element 28).

In this case, the light BLc1 reflected off the first reflector 32a has a small amount of disturbance in the polarization state as compared with a case where the excitation light having passed through the phosphor layer 32 and having been then reflected back off the second reflector 32b is used as the illumination light WL, whereby the polarization separation element 50B can reflect the light incident thereon with increased reflectance. As a result, illumination light WL having a high color temperature can be efficiently provided. Further, the lighting device 20B can be more compact and lightweight than a lighting device of related art.

Therefore, when the thus configured lighting device 20B is used as the lighting device 2 provided in the projector 1, the size and weight of each of the lighting device 2 and the projector 1 can be reduced with images displayed in excellent image quality.

The invention is not necessarily limited to the embodiments described above and a variety of changes can be made thereto to the extent that the changes do not depart from the subject of the invention.

For example, in the embodiments described above, the array light source 21 having a plurality of semiconductor lasers 21a arranged therein is presented by way of example, but each of the lighting devices 20A and 20B does not necessarily have the light source configuration described above and may include a single light source. Further, the semiconductor lasers 21a can be used as preferable light sources, but each of the light sources may, for example, be a light emitting diode (LED) or any other solid-state light emitting device.

Further, in the embodiments described above, the projector 1 including the three light modulators 4R, 4G, and 4B is presented by way of example, but the invention is also applicable to a projector that displays color video images based on a single light modulator. Moreover, each of the light modulators is not limited to a liquid crystal panel and can, for example, be a digital mirror device.

Further, each of the lighting devices 20A and 20B is provided with the first reflector 32a and the second reflector 32b in the phosphor layer 32, but the first reflector, which reflects part of the excitation light BLc traveling toward the phosphor layer 32 or the light BLc1, and the second reflector, which reflects part of the fluorescence light produced by the phosphor layer 32 or the light YL1, can be members separate from the phosphor layer 32. In this case, the first reflector may be disposed in the optical path between the phosphor layer 32 and the retardation film 26. On the other hand, the second reflector may be disposed on the opposite side of the phosphor layer 32 to the side where the excitation light BLc2 is incident.

The entire disclosure of Japanese Patent Application No. 2013-053727, filed on Mar. 15, 2013 is expressly incorporated by reference herein.

What is claimed is:

1. A lighting device comprising:
a light source that emits a first light flux of a first wavelength band;
a fluorescence light emitting element including a phosphor layer and a base that supports the phosphor layer, the phosphor layer producing, when excited by light of the first wavelength band, light of a second wavelength band different from the first wavelength band;
a polarization separation element that is provided in an optical path between the light source and the phosphor layer, has a polarization separation function for light of the first wavelength band, and transmits or reflects light of the second wavelength band;
a retardation film disposed in an optical path between the polarization separation element and the phosphor layer;
a first reflector that is disposed in an optical path between the retardation film and the phosphor layer, reflects part of the first light flux toward the polarization separation element, and transmits other part of the first light flux toward the phosphor layer; and
a second reflector that is disposed on the opposite side of the phosphor layer to the first reflector and reflects the light produced by the phosphor layer.

2. The lighting device according to claim 1,
wherein a quarter wave plate is used as the retardation film.

3. The lighting device according to claim 1,
wherein the first reflector is a diffusive reflection surface.

4. The lighting device according to claim 3,
wherein the diffusive reflection surface is formed by performing texture processing or dimple processing on a surface of the phosphor layer.

5. The lighting device according to claim 1,
wherein the second reflector is a mirror-finished reflection surface.

6. The lighting device according to claim 5,
wherein the mirror-finished reflection surface is a reflection film provided between the phosphor layer and the base.

7. The lighting device according to claim 5,
wherein the base is disposed on the opposite side of the phosphor layer to a surface thereof on which the other part of the first light flux is incident, and
the mirror-finished reflection surface is a light reflective surface of the base.

8. The lighting device according to claim 1,
wherein the phosphor layer is attached to the base with a light reflective, inorganic adhesive provided on a side surface of the phosphor layer.

9. The lighting device according to claim 1,
wherein a semiconductor laser is used as the light source, and
the polarization direction of the first light flux incident on the polarization separation element coincides with one of the polarization direction of polarized light that the polarization separation element transmits and the polarization direction of polarized light that the polarization separation element reflects.

10. The lighting device according to claim 9,
wherein an array light source having the semiconductor laser disposed therein in a plurality of positions is used as the light source.

11. The lighting device according to claim 1,
wherein a collimator optical system is disposed between the light source and the polarization separation element.

12. A projector comprising:
a lighting device that radiates illumination light;
a light modulator that modulates the illumination light in accordance with image information to form image light; and
a projection optical system that projects the image light,
wherein the lighting device is the lighting device according to claim 1.

13. A projector comprising:
a lighting device that radiates illumination light;
a light modulator that modulates the illumination light in accordance with image information to form image light; and
a projection optical system that projects the image light,
wherein the lighting device is the lighting device according to claim 2.

14. A projector comprising:
a lighting device that radiates illumination light;
a light modulator that modulates the illumination light in accordance with image information to form image light; and
a projection optical system that projects the image light,
wherein the lighting device is the lighting device according to claim 3.

15. A projector comprising:
a lighting device that radiates illumination light;
a light modulator that modulates the illumination light in accordance with image information to form image light; and
a projection optical system that projects the image light,
wherein the lighting device is the lighting device according to claim 4.

16. A projector comprising:
a lighting device that radiates illumination light;
a light modulator that modulates the illumination light in accordance with image information to form image light; and
a projection optical system that projects the image light,
wherein the lighting device is the lighting device according to claim 5.

17. A projector comprising:
a lighting device that radiates illumination light;
a light modulator that modulates the illumination light in accordance with image information to form image light; and
a projection optical system that projects the image light,
wherein the lighting device is the lighting device according to claim 6.

18. A projector comprising:
a lighting device that radiates illumination light;
a light modulator that modulates the illumination light in accordance with image information to form image light; and
a projection optical system that projects the image light,
wherein the lighting device is the lighting device according to claim 7.

19. A projector comprising:
a lighting device that radiates illumination light;
a light modulator that modulates the illumination light in accordance with image information to form image light; and
a projection optical system that projects the image light,
wherein the lighting device is the lighting device according to claim 8.

20. A projector comprising:
a lighting device that radiates illumination light;
a light modulator that modulates the illumination light in accordance with image information to form image light; and
a projection optical system that projects the image light,
wherein the lighting device is the lighting device according to claim 9.
